(19) United States
(12) Patent Application Publication
(10) Pub. No.: US 2005/0139542 A1
(43) Pub. Date: Jun. 30, 2005

(54) Stiffened surface micromachined structures and process for fabricating the same

(76) Inventors: David L Dickensheets, Bozeman, MT (US); Todd J. Kaiser, Bozeman, MT (US); Philip A. Himmer, Bozeman, MT (US); Jeffrey Lutzenberger, Bozeman, MT (US); Robert A. Friholm, Beaverton, OR (US)

Correspondence Address: MORGAN LEWIS & BOCKIUS LLP, 1111 PENNSYLVANIA AVENUE NW, WASHINGTON, DC, 20004, US

(21) Appl. No.: 10/493,140

(22) PCT Filed: Oct. 21, 2002
(86) PCT No.: PCT/US02/33351

Related U.S. Application Data
(60) Provisional application No. 60/330,433, filed on Oct. 22, 2001.

(51) Int. Cl. B01D 29/00

(52) U.S. Cl. 210/490

(57) ABSTRACT

Stiffened surface micromachined structures and a method to fabricate the same. A silicon substrate (10) is first etched to produce a mold containing a plurality of trenches or grooves (14) in a lattice configuration. Sacrificial oxide (15) is then grown on the silicon substrate (10) and then a stiffening member (16) (silicon nitride) is deposited over the surface of the substrate, thereby backfilling the grooves with silicon nitride. The silicon nitride is patterned to form mechanical members and metal (40) is then deposited and patterned to form the leads and capacitors for electrostatic actuation of mechanical members. The underlying silicon and sacrificial oxides are removed by etching the mold from underneath the fabricated micromachined devices, leaving free-standing silicon nitride devices with vertical ribs. The devices exhibit increased out-of-plan bending stiffness because of the presence of stiffening ribs. Silicon nitride biaxial pointing mirrors with stiffening ribs are also described.

### REFERENCE TO RELATED APPLICATIONS

This application claims priority benefits of prior filed co-pending U.S. provisional patent application Ser. No. 60/330,433, filed on Oct. 22, 2001, the disclosure of which is incorporated herein by reference in its entirety.

### BACKGROUND

1. Field of the Invention

The present invention generally relates to micromachined structures and their fabrication methods, and, more particularly, to a micromachined device with stiffening members to reduce stress-induced or inertial deformation and a method of fabricating the same.

2. Description of Related Art

All publications and patent applications herein are incorporated by reference to the same extent as if each individual publication or patent application was specifically and individually indicated to be incorporated by reference.

The Internet, cable television and teleconferencing has highlighted the increased requirement for communication bandwidth. The use of dense wavelength division multiplexing (DWDM) has increased the number of wavelengths carried on each optical fiber used to meet these high bandwidth requirements. These multiple wavelengths must be switched and rerouted to different fibers. The current method of converting the optical signal at each wavelength to slower electrical signals, switching, and then converting back to optical signals and transmitting back down an optical fiber has become the dominant power and space consumer of fiber communication systems. Therefore, it is desirable to develop an all-optical switching method to meet the demand for increased optical communication bandwidth.

Micromechanical mirror systems are one method of obtaining all-optical switching. The small nature of an optical fiber makes the beam compatible with micromechanical mirrors. Movable micromechanical mirrors can be used to redirect the optical beam between fibers. This presents significant problems for the design of micromechanical mirrors.

Surface micromachined devices are constructed from thin films containing internal stresses resulting from their fabrication process. As a result of these internal stresses, devices with high length-to-thickness ratios can deform considerably once released from the substrate. For example, the tip of a rectangular cantilever beam will tend to deflect out of the plane of the substrate when released. One class of devices particularly sensitive to surface deformation is micro mirrors used for optical cross-connects and in scanned-beam imaging systems. These mirrors may require diameters of several hundred micrometers, leading to very large length-to-thickness ratios. An ideal mirror would have an optically flat surface so that the reflected beam is not significantly deformed. This will aid in the coupling efficiency into the optical fiber. Deformation of the mirror surface translates to aberrations of the optical beam, leading to large insertion loss in the case of an optical switch and poor fidelity in an imaging system. For these reasons, surface micromachined mirrors have lagged behind single-crystal silicon mirrors for these high-performance optical applications.

An ideal micromachined mirror should also have a large dynamic range. The greater the tilt angle of the mirror, the more fibers can be used in the optical cross connect reducing the total number of cross connects required. The mirror, however, should be easily produced. Complex and exotic processes increase the production costs and reduce the yield, raising the ultimate cost of the cross connect.

Residual stress during fabrication of a micromachined device can be partially reduced by controlling deposition conditions, by annealing deposited films, and by multilayer designs that attempt to balance stresses in a laminate structure. However, film stress remains a variable in most deposition systems, and solutions are needed that can increase the tolerance of a particular design to variation in film stresses.

By increasing the moment of inertia of a micromachined structure, deformations due to residual stresses can be significantly reduced. This approach has been employed in the past by introducing corrugations or trenches into the surface prior to film deposition as described in (1) Hung-Yi Lin, Mingching Wu, Weileun Fang, “The Improvement of Micro-torsional-mirror for High Frequency Scanning,” SPIE 4178, 2000, (2) Joe Drake, Hal Jerman, “A Micromachined Torsional Mirror for Track Following in Magneto-optical Disk Drives,” Solid-State Sensor and Actuator Workshop, 2000, and (3) Hung-Yi Lin, Weileun Fang, “Rib-reinforced Micromachined Beam and its Applications,” J. Micromech. Microeng., 10, 93-99, 2000. Furthermore, torsional mirrors that have used magnetics and electrostatics for actuation and that have been produced using a variety of fabrication techniques have been described in (1) K. E. Petersen, “Silicon Torsional Scanning Mirrors,” IBM J. Res. Develop., 24, pp. 631-637, 1980, (2) L. J. Hornbeck, “Deformable Mirror Spatial Light Modulators,” Proc. SPIE, 1150, pp. 1-17, 1989, (3) M. Fischer, H. Graef, W. von Münch, “Electrostatically Deflectable Polysilicon Torsional Mirrors,” Sens. Actuators A, 44, pp. 83-89, 1994, and (4) A. S. Dewa, J. W. Orcutt, M. Hudson, D. Krozier, A. Richards, H. Laor, “Development of a Silicon Two-Axis Micromirror for Optical Cross-Connect,” 2000 Solid-State Sensor and Actuator Workshop, pp. 93-96, 2000.

Bulk micromachining has produced flat silicon mirrors with large deflection angles, but uses complicated processing techniques, layer bonding or expensive substrate wafers. Such bulk micromachining is described in (1) D. W. Wine, M. P. Helsel, L. Jenkins, H. Urey, T. D. Osborn, “Performance of a Biaxial MEMS-Based Scanner for Microdisplay Applications,” Proc. SPIE, 4178, pp. 186-196, 2000, and (2) D. Dickensheets, G. Kino, “Microfablicated Biaxial Electrostatic Torsional Scanning Mirrors,” Proc. SPIE, 3009, pp. 141-150, 1997. On the other hand, surface micromachining techniques have generated mirrors with small angular deflection with small actuation voltages, but were pliable and were subject to deformation upon actuation. Creating standoffs to raise the mirror above the surface can increase the angle of deflection for surface micromachined mirrors, but this adds complexity to the fabrication process as described in V. A. Aksyuk, F. Pardo, C. A. Bolle, S. Arney, C. R; Giles, D. J. Bishop, “Lucent Microstar Micromirror Array Technology for Large Optical Crossconnects,” Proc. SPIE, 4178, pp. 320-324, 2000. The surface micromachined structure can be stiffened by adding topology to the substrate that creates stiffening beams and ribs in the deposited material. These beams and ribs are used to add structural integrity to the mechanical members as discussed in (1) H. Y. Lin, W. Fang, “Rib-reinforced Micromachined Beam and its Applications,” J. Micromech. Microeng., 10, pp. 93-99, 2000, and (2) J. Drake, H. Jerman, “A Micromachined Torsional Mirror for Track Following in Magneto-optical Disk Drives,” 2000 Solid-State Sensor and Actuator Workshop, pp. 10-13, 2000.

Despite the foregoing methods of fabricating micromachined structures and mirrors, it is still desirable to produce micromachined structures that can be made stiffer (i.e., with substantially reduced deformation due to internal stresses or excitation of unwanted vibration modes during dynamic operation) and have larger angular deflections (especially in the case of micromachined mirrors). The 3-dimensional surface micromachined structures should preferably have increased stiffness to reduce the deformation resulting from stress gradients in materials and differential stresses in laminated films. It is further desirable to devise a fabrication method that produces such micromachined structures with ease and simplicity. It is also desirable to develop a silicon micromachining process that uses industry-standard processing steps to realize highly functional micromechanical devices, especially, micro mirrors for optical switching applications.

### SUMMARY

In one embodiment, the present invention contemplates a method of fabricating a thin-film micromachined device comprising etching a substrate to produce a mold therein; depositing a structural stiffening member on the substrate so as to backfill the mold with the structural stiffening member; patterning the stiffening member deposited on the substrate to form the thin-film micromachined device on the substrate; and etching the mold to release the micromachined device without removing the stiffening member that is backfilling the mold.

In another embodiment, the present invention contemplates a micromachined device comprising a structural stiffening member; and a thin-film micromachined structure formed from the stiffening member by patterning the stiffening member, wherein the stiffening member is initially deposited on a substrate backfilling a mold etched into the substrate, and wherein the mold is selectively etched after formation of the micromachined structure so as to release the micromachined structure without removing the stiffening member that is backfilling the mold.

The mold may be produced in a number of lattice configurations including, for example, a ring configuration or a honeycomb configuration. In one embodiment, the structural stiffening member includes one or more silicon nitride layers deposited on a silicon substrate. One or more layers of metal are also deposited and patterned on the stiffening member to form leads and capacitors for electrostatic actuation. Further, a portion of the mold is left incorporated into the released micromachined device for increased stiffness.

In a still further embodiment, the present invention contemplates a micromachined mirror comprising a structural stiffening member containing at least one layer of silicon nitride; one or more mechanical members formed from the stiffening member by patterning the stiffening member; and one or more layers of metal deposited and patterned on the stiffening member so as to form a reflective portion of the micromachined mirror and one or more electrostatic actuators for the mechanical members, wherein the stiffening member is initially deposited on a silicon substrate backfilling a mold etched into the substrate, and wherein the mold is selectively etched after patterning the one or more metal layers so as to release the micromachined mirror without removing the stiffening member that is backfilling the mold.

The micromachined devices built with vertical features or fins or ribs created by molding the substrate and backfilling the mold with silicon nitride exhibit increased out-of-plane bending stiffness. The increased bending stiffness resulting from stiffening fins or ribs substantially reduce stress-related deformations experienced by surface-micromachined devices with large length-to-thickness ratios. Thus, by using surface micromachining techniques to pattern stiffened micromachined devices out of silicon nitride and then releasing them by a sacrificial oxide etch and bulk etching of the silicon substrate, the out-of-plane deformation of the released micromachined structures can be significantly reduced.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 illustrates an abbreviated fabrication process flow according to the present invention depicting a cantilever beam fabricated with trenches;

FIG. 2 shows trenches forming a double ring configuration when etched into a silicon substrate;

FIG. 3 illustrates an exemplary shape for one of the trenches depicted in FIG. 2;

FIG. 4 depicts four exemplary configurations for trenches or stiffening lattice that can be produced to stiffen surface micromachined structures;

FIG. 5 illustrates a top view and a cross-sectional view of an exemplary micromachined device (a bi-axial micro mirror) formed upon release from the substrate;

FIG. 6 illustrates an isometric view of an exemplary biaxial micro mirror released from the substrate after being formed according to the process depicted in FIG. 1;

FIG. 7 illustrates some exemplary lattice (or trench) configurations for cantilever beams fabricated according to the process discussed with reference to FIG. 1;

FIG. 8 shows experimental dimensions (in μm) for three types of cantilever beams—a beam having a flat cross section, a beam having a “T” cross section, and a beam having a “C” cross section;

FIG. 9 shows optical interferometer images of exemplary micromachined cantilever beams with six different cross sections fabricated according to the process described with reference to FIG. 1;

FIG. 10 depicts exemplary graphs showing displacement measured along the length of silicon nitride cantilevers for four different beam cross sections, corresponding to the top four cantilevers in FIG. 9;

FIG. 11 shows the residual curvature or displacements measured for the same cantilevers as those shown in FIG. 10, but after sputtering 100 nm of gold on the surface of silicon nitride beams of FIG. 10;

FIG. 12 illustrates an exemplary schematic of a silicon nitride cantilever beam used for finite element analysis of various beam configurations according to one embodiment of the present invention;

FIG. 13 is a finite element model corresponding to the cantilever beam schematic shown in FIG. 12;

FIG. 14 illustrates four finite element models for different cantilever beam configurations generated using the schematic illustrated in FIG. 12;

FIG. 15 depicts simulated cantilever displacements for four different beam cross-sections as predicted by the finite element analysis;

FIG. 16 is a bottom-side view of a portion of a released lattice structure illustrating inclusion of silicon in the stiffening lattice for a micromachined stricture;

FIG. 17 illustrates an exemplary released bi-axial micro mirror with standard torsional hinges;

FIG. 18 illustrates an exemplary released bi-axial micro mirror with meander hinges;

FIG. 19 shows some details of an inner flexure for the released bi-axial mirror in FIG. 17; and

FIG. 20 shows the backside of another biaxial mirror fabricated using the process described with reference to FIG. 1.

### DETAILED DESCRIPTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements found in a typical micromachining process or micromachined device.

It is worthy to note that any reference in the specification to “one embodiment” or “an embodiment” means that a particular feature, structure or characteristic described in connection with the embodiment is included in at least one embodiment of the invention. The appearances of the phrase “in one embodiment” at various places in the specification do not necessarily all refer to the same embodiment.

Process Flow

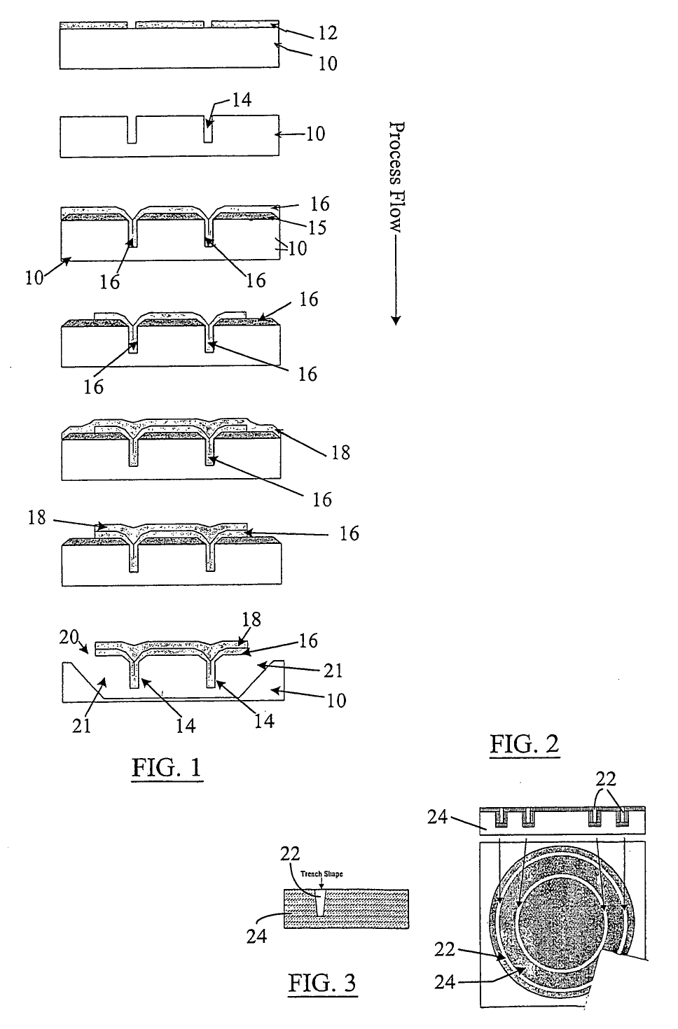

FIG. 1 illustrates an abbreviated fabrication process flow according to the present invention depicting a cantilever beam 20 fabricated with trenches 14. The process in FIG. 1 is described hereinbelow in conjunction with FIGS. 2-6. The process illustrated in FIG. 1 is a multi-step process, with the beginning step shown at the top and the concluding step shown at the bottom in FIG. 1. The fabrication flow shown in FIG. 1 is a modification of the process used to produce silicon nitride deformable membranes as discussed in D. L. Dickensheets, P. A. Himmer, R. A. Friholm, B. J. Lutzenberger, “Miniature High-resolution Imaging System with 3-dimensional MOEMS Beam Scanning for Mars Exploration,” Proc. SPIE, 4178, pp. 90-97, 2000. Instead of using the backfllling of deep reactive ion etched silicon trenches for an etch stop as discussed in the publication noted in the previous sentence, the backfilled trenches become part of the structural members as discussed hereinbelow.

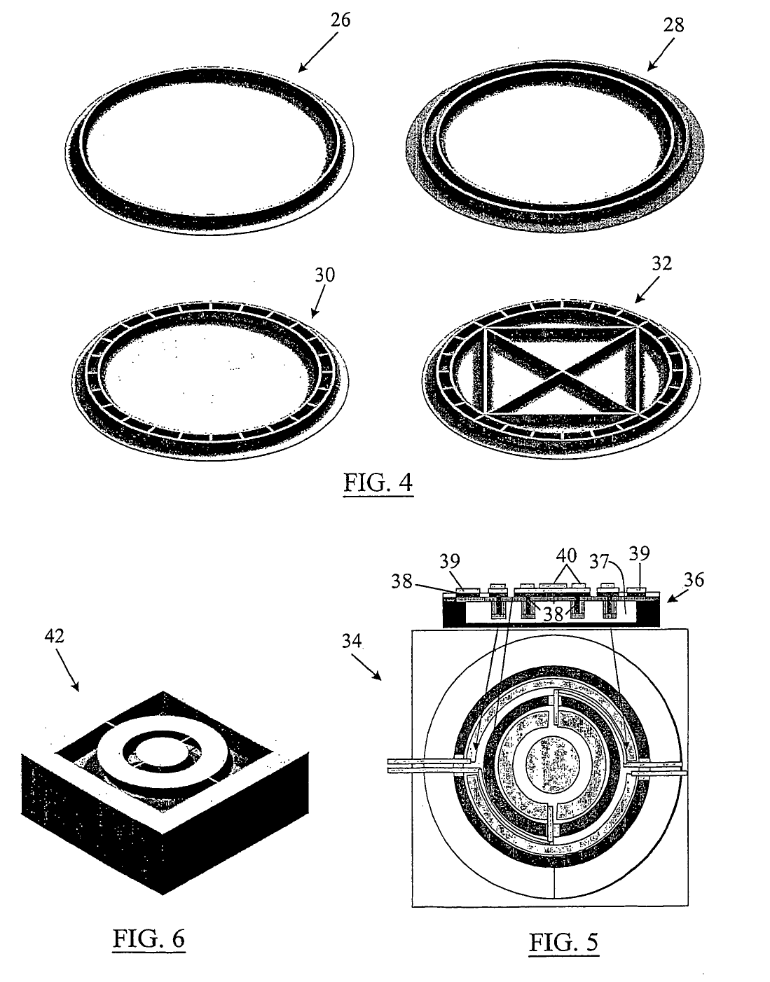

As shown in FIG. 1, initially, a silicon substrate or wafer 10 is masked with a DRIE (Deep Reactive Ion Etching) mask 12 and deep trenches 14 are etched in bulk silicon 10 using DRIE etching with short iteration times to minimize the typical scalloping of the sidewalls as discussed in A. A. Ayon, R. Braff, C. C. Lin, H. H. Sawin, M. A. Schmidt, “Characterization of a Time Multiplexed Inductively Coupled Plasma Etcher,” J. Electrochem. Soc., 146, pp. 339-349, 1999, the disclosure of which is incorporated herein in its entirety. The trenches 14 could be formed in many configurations. For example, FIG. 2 illustrates trenches 22 forming a double ring configuration when etched into a silicon substrate 24. FIG. 3 illustrates an exemplary shape for one of the trenches 22 depicted in FIG. 2. The configuration of the trenches produces a mold or stiffening lattice (e.g., the double ring configuration in FIG. 2) for the stiffening members of the final structure. FIG. 4 illustrates four exemplary configurations for trenches or stiffening lattice that can be produced to stiffen surface micromachined structures. The shapes in FIG. 4 are the backside of various configurations including the single ring configuration 26, the multiple ring configuration 28, the webbed rings configuration 30, and the honeycombed structure 32. Any other suitable lattice configuration may be produced independently or using one or more configurations shown in FIG. 4.

After trenches have been etched into the silicon, oxide is thermally grown and/or deposited on the silicon substrate 10, which is followed by deposition of phosphosilicate glass (PSG) to form a sacrificial oxide layer 15 between the substrate 10 and the stiffening member (here, the silicon nitride layers 16, 18). The thermally grown oxide conformally coats the surface of the substrate 10. The trenches are then backfilled with a structural material or stiffening member to create vertical flanges that significantly increase the overall bending stiffness of the resulting micromachined device. In one embodiment, the structural members for the micromachined device (e.g., a micro mirror) are formed out of two layers of silicon nitride. After patterning the sacrificial oxide layer 15, the trenches 14 are backfilled with a first layer of silicon nitride 16. This first layer of stiffening member (here, silicon nitride) forms the mechanical members of the micromachined device when it is patterned and appropriately etched. A second nitride layer 18, usually a thinner layer, may be then deposited over the entire surface of the substrate and patterned to define the flexures in the micromachined device. This allows for an increased design space, with the flexure thickness being the additional design variable. Thereafter, metals may be deposited and patterned (not shown in FIG. 1, but illustrated in FIGS. 5 and 6) as needed to form the leads and capacitors for the electrostatic actuation of the micromachined device.

The micromachined devices are then released from the surface of the substrate by wet etching the sacrificial PSG and thermal oxide with, for example, a concentrated hydrofluoric acid (HF) solution, followed by anisotropic etching of the silicon substrate 10 in a tetramethyl ammonium hydroxide (TMAH) solution ((CH₃)₄NOH) to produce clearance for mechanical motion. In other words, the substrate 10 itself may be considered a “sacrificial material” in the fabrication process. A released cantilever 20 with desired clearance 21 between the released device and the substrate 10 is shown in the drawing at the bottom in FIG. 1.

FIG. 5 illustrates a top view 34 and a cross-sectional view 36 of an exemplary micromachined device (a bi-axial micro mirror) formed upon release from the substrate. The cross-sectional view 36 is a horizontal slice taken through the middle of the device (i.e., horizontally through the middle of the top view 34) and depicts a metal layer 40 deposited and patterned on top of two layers 38, 39 of structural stiffening member or material (here, silicon nitride layers). Further, as shown in FIG. 5, a substantially uniform or flat air gap 37 may be created at will under the released structure by appropriately timing the release etch process. The size of the air gap 37 is variable and it depends on the duration of the etching of the mold. Using TMAH for the release may result in very flat (to a few micrometers) air gaps, even though the initial etch patterns (for micromachined structures) are complex and dependent on the geometry of the structures to be released. Thus, by etching the mold, an air gap (e.g., the air gap 37 in FIG. 5) of controllable thickness may be generated, and that air gap may be uniformly flat beneath the released device.

FIG. 6 illustrates an isometric view 42 of an exemplary biaxial micro mirror released from the substrate after being formed according to the process depicted in FIG. 1. In the structure shown in FIG. 6, chrome-gold is deposited and patterned to form the reflective surface, the electrodes, interconnects, the surface capacitor plates and bonding pads for the micro mirror device assembly. Actuation electrodes are positioned on the outer member to deflect the structure about the axis defined by the outer flexures and on the inner electrodes to deflect the structure about the axis defined by the inner flexures. Actuation is made by applying a potential between the substrate and the electrodes on the surface of the device.

The thermal oxide and phosphosilicate glass layers together serve as a sacrificial layer which later may be etched through access vias in the structural material to expose the top surface of the silicon mold when it is time to release the micromachined structures by etching the silicon mold. The presence of thermal oxide under the nitride layer(s) may dramatically increase the breakdown voltage for the fabricated micromachined structures. Breakdown occurs away from the released devices, between the metal layer and the silicon substrate where the films are all in contact with the silicon. The low-stress silicon breaks down at low voltages. Therefore, having a good dielectric (like thermal oxide) under the nitride layer(s) may allow application of several hundred volts of potential across the device films without breakdown.

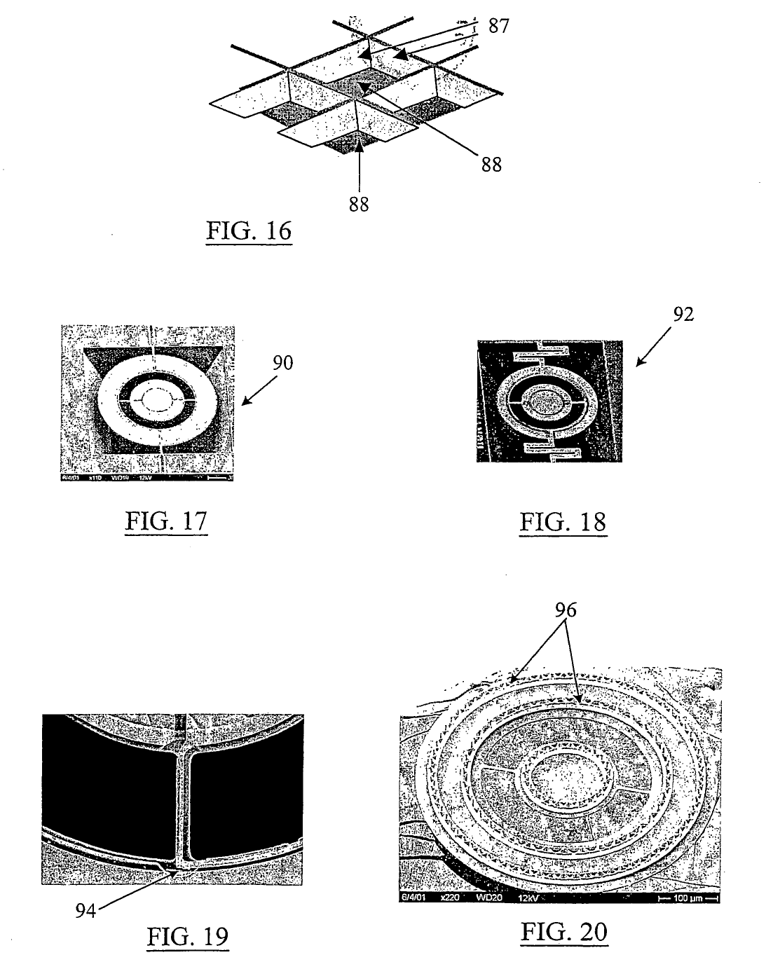

In one embodiment, the thermal oxide layer is optional. In other words, after trenches have been etched into the silicon substrate, low stress LPCVD silicon nitride is deposited directly on the substrate without thermal oxide or phosphosilicate glass first deposited. The silicon nitride layer is patterned to form the micromechanical device, and metal layers may be deposited and patterned as needed to form the leads and capacitors for the electrostatic actuation of the micromachined device. The device is released by etching the silicon through access vias in the silicon nitride, or from around and under the micromachined device using a selective etchant that removes the silicon in the substrate without removing the micromachined device. Depending on the silicon etchant and the orientation of the trench pattern with respect to the crystal lattice, some of the silicon may remain integral to the finished micromachined device, as illustrated and discussed hereinbelow with reference to FIG. 16.

In one embodiment, trenches measuring approximately 2.5 μm wide were etched into bulk silicon using deep reactive ion etching with the Bosch process. This was followed by a growth of thermal oxide (˜1.0 μm) and then deposition of phosphosilicate glass (PSG) at 400° C. (˜0.5 μm). Thermal oxide grows conformally around the etched trench, but PSG typically does not coat the trench sidewalls and bottom. In this embodiment, the trench depth used was approximately 10 μm-12 μm. However, if needed, trenches exceeding 30 μm deep (and upto 100 μm deep) and about 2 μm wide may be etched and filled. A 1.0 μm thick layer of low-stress LPCVD (low pressure chemical vapor deposited) silicon-nitride was then deposited and patterned using standard photolithography and reactive ion etching. A second layer of silicon nitride 0.5 μm thick was deposited and patterned similarly to complete the trench filling. A good conformal coating by the silicon nitride layer is obtained. Then the devices were released from the silicon substrate surface by wet etching the oxide in concentrated hydrofluoric acid, followed by silicon etching in TMAH to release the cantilevers (one such cantilever 20 is shown in FIG. 1) and achieve the desired clearance between released devices and the substrate. For metal-coated cantilevers, 100 μm gold was sputtered on the released devices. The devices were fabricated at the Stanford Nanofabrication Facility, USA.

Thus, deep RIE etching may be used to pre-structure the substrate with trenches prior to deposition of thin films. The trenches can be back-filled with a structural material, such as low-stress silicon nitride, to create vertical flanges that significantly increase the overall bending stiffness of the resulting MEMS (microelectromechanical systems) device. Various flange configurations beneath a micromachined device may be formed to significantly increase the height to width aspect ratio of the device, thus increasing the overall bending stiffness. Experimental results, discussed later hereinbelow, show that the static deflection of micromachined cantilever beams was significantly reduced by the addition of various flange configurations deposited using the process described with reference to FIG. 1. The back-filled trenches may serve as a lateral etch stop during the release of surface micromachined structures.

Further, the vertical silicon nitride members are part of the released silicon nitride structures.

With the process described with reference to FIG. 1, surface micromachined structures of silicon nitride can be produced with nearly arbitrary control of the depth of the vertical members in the structures.

Beam Theory

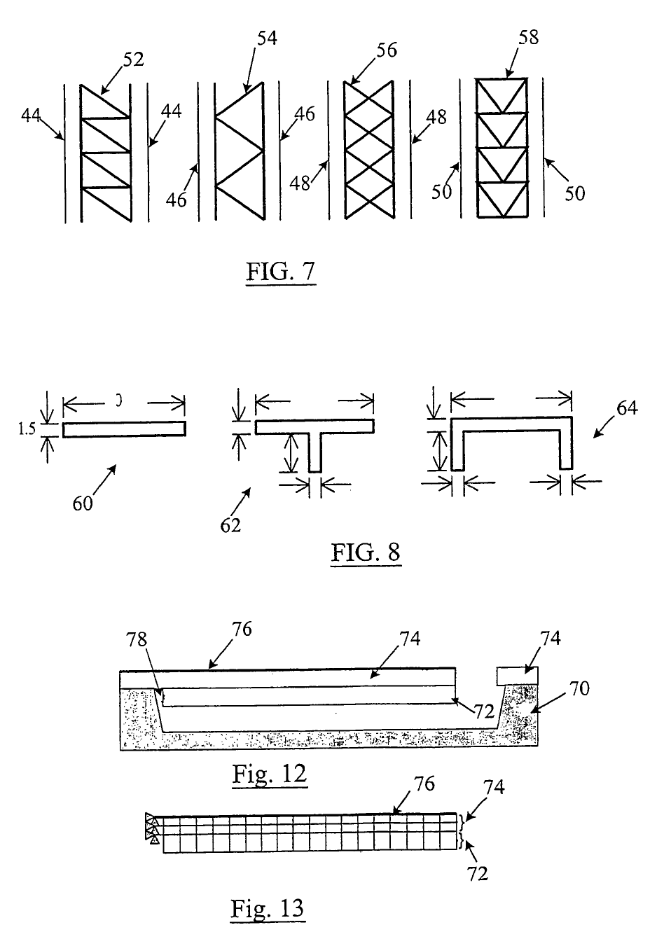

FIG. 7 illustrates some exemplary lattice (or trench) configurations for cantilever beams fabricated according to the process discussed with reference to FIG. 1. The light lines 44, 46, 48 and 50 show the edges of cantilever beams and the dark lines 52, 54, 56 and 58 represent the trenches in different configurations. Before discussing results of experimental surface deformation measurements for various lattice configurations and before discussing FEA (Finite Element Analysis) simulations of cantilever beams of various cross sections and lattice configurations, it is pertinent to discuss beam theory as applied to selected types of cantilever beams. FIG. 8 shows experimental dimensions for three types of cantilever beams—a beam having a flat cross section 60, a beam having a “T” cross section 62 (T-beam), and a beam having a “C” cross section 64 (C-beam). All dimensions shown in FIG. 8 are in microns and are used to obtain the moment of inertia values of respective beams as discussed hereinbelow.

For small deflections, a cantilever beam subjected to a moment M will bend according to the following equation:

$$\frac{\partial θ}{\partial x} = k = - \frac{M}{EI} \qquad ( 1 )$$

In equation (1), k is the curvature, E is the modulus of elasticity and I is the moment of inertia. The moment of inertia of a cantilever beam with a rectangular cross-section is given by:

$${I}_{xx} = \frac{{bh}^{3}}{12} \qquad ( 2 )$$

In the equation (2) above, h is the thickness of the beam and b is the width of the beam. Substituting equation (2) into equation (1), one observes that the curvature k decreases proportional to h³. Thus, for a beam with a rectangular cross section and a fixed width, increasing the film thickness by h decreases the curvature by 1/h³.

For composite cross-sections such as those shown in FIG. 8, the moment of inertia becomes:
Iₓₓ=Σ(Iₓₓₙ+Aₙdₙ²) (3)
In equation (3), Iₓₓₙ is the moment of inertia of the n^{th} piece, Aₙ is the area of the n^{th} piece and dₙ is the perpendicular distance between the centroid of the n^{th} piece and the centroid of the entire composite cross-section.

FIG. 8 shows dimensions for some typical beams. If the modulus of elasticity is assumed to be constant, then according to equation (1), stiffness can only be improved by increasing the moment of inertia. The composite moment of inertia can be calculated for the cross-sections shown in FIG. 8 to illustrate its effect on bending stiffness. The moments of inertia (measured in μm⁴) calculated from equation (3) by using the dimensions for the flat, T-beam and C-beam shown in FIG. 8 are 7.0, 414.1, and 633.4 respectively. Thus, both the T-beam and the C-beam are significantly stiffer in bending than the flat beam.

Since many useful flange configurations do not exhibit a constant cross-section along the length of the beams, the use of a generalized stiffness based on a modified flexural rigidity may not be always preferable. The modified flexural rigidity can be determined analytically and with finite element analysis. By measuring the static deflection of the beams it is possible to determine a bulk or modified flexural rigidity. Useful lattice configurations that can be used for such measurements are shown in FIG. 7.

Experimental Results

FIG. 9 shows optical interferometer images of exemplary micromachined cantilever beams with six different cross sections fabricated according to the process described with reference to FIG. 1. The end view and top view of each cantilever beam is also shown in FIG. 9 along with its interferometer image. As noted with reference to FIG. 7, the light lines in the top views in FIG. 9 show the edges of the corresponding cantilever beam and the dark lines represent the trenches. The devices fabricated according to the process in FIG. 1 may be characterized by measuring surface deformation of released cantilevers. Both silicon nitride and gold-coated silicon nitride structures have been investigated. The primary experimental tool for making surface deformation measurements is an optical profilometer, consisting of a Mirau interferometer (imaging at 660 nm) and custom fringe analysis software for extracting surface profiles. Each fringe in the images shown in FIG. 9 represents a 330 nm change in surface height. Typically, the substrate is tilted from the optical axis, producing linear fringes across flat surfaces.

All of the cantilevers in FIG. 9 measure 100 μm wide by 300 μm long, and are made of low stress LPCVD silicon nitride approximately 1 μm thick, with no other films. The vertical stiffening elements or trenches are 12 μm deep and approximately 2 μm wide. The first device (i.e., the device at the top in FIG. 9) is a simple flat nitride cantilever. For the first device, there is a small stress gradient in the silicon nitride that causes it to bend upward, with a tip deflection of 2.2 μm above the plane of the wafer. Cupping of the cantilever in both dimensions is evident by the curved fringes in the interferogram.

The second (T-cross section) and third (C-cross section) cantilevers from the top in FIG. 9 are examples of linear stiffening elements. In both cases, the curling along the length of the cantilever is significantly reduced compared to the simple nitride film cantilever at the top in FIG. 9. Both of the “T” and “C” cross section devices exhibit curling laterally across the cantilever, however, as much as a full fringe (330 nm) for the T-cross section device.

The bottom three cantilevers in FIG. 9 are examples of different lattices that are essentially a C-channel cross section with lateral elements to tie the two outer vertical elements together (as seen from the respective end views in FIG. 9). In FIG. 9, the fourth cantilever from the top is a simple triangular lattice, and the fifth is a diamond or X-lattice. Both of these exhibit very good flatness in both dimensions, with straight, evenly spaced fringes. The bottom cantilever is an example of an asymmetric triangular lattice. In this case, the bending moment due to the stress gradient in the silicon nitride leads to a twisting of the cantilever. Such structures could be useful for asymmetric torsion elements.

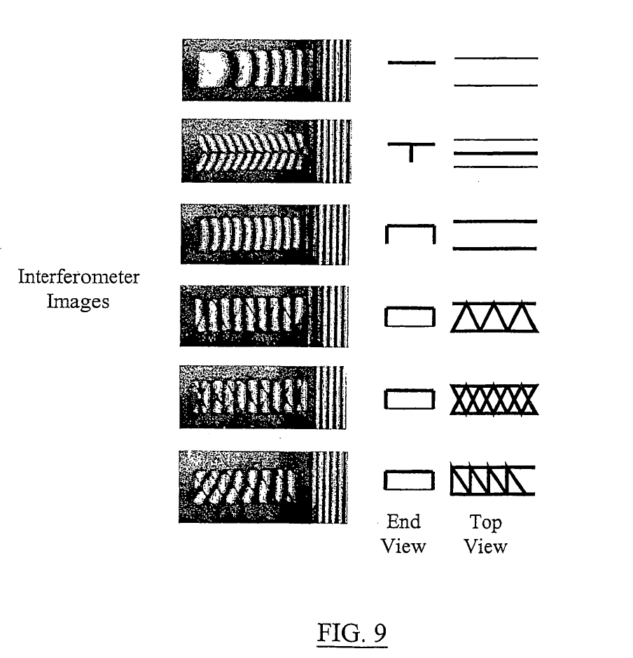

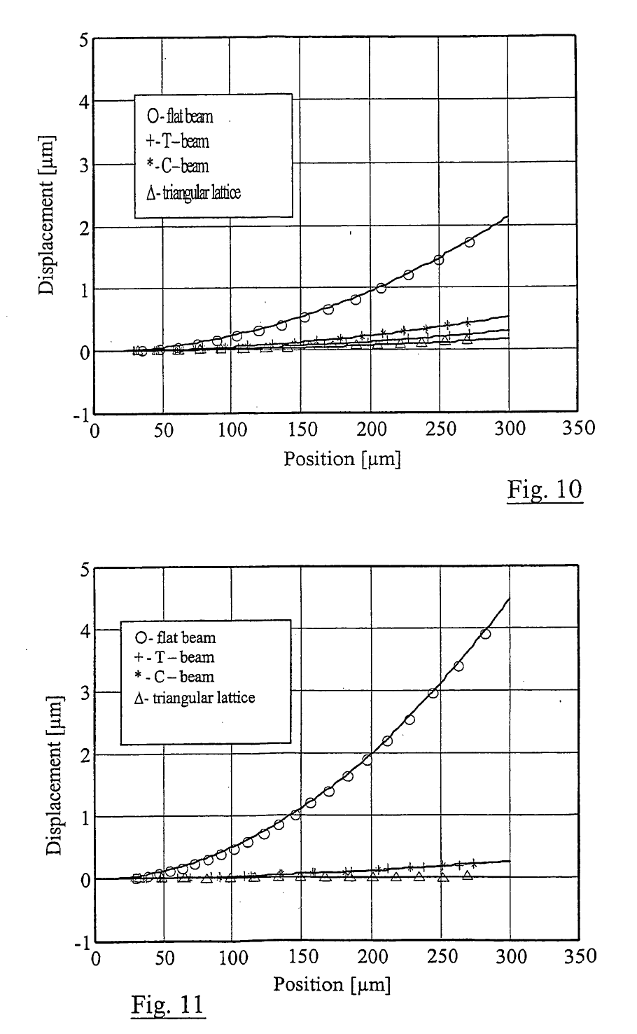

FIG. 10 depicts exemplary graphs showing displacement measured along the length of silicon nitride cantilevers for four different beam cross sections, corresponding to the top four cantilevers in FIG. 9. The data in FIG. 10 were taken for cantilevers that were 300 μm long and 50 μm wide, with 12 μm deep vertical members or stiffening structures (or trenches). As can be seen from the graphs in FIG. 10, cantilever bending (due to stress gradient in the nitride) is significantly reduced for all of the beams with vertical stiffening elements, compared to the beam without any vertical elements. The flattest cantilever of the group is the cantilever with triangular lattice. FIG. 11 shows the residual curvature or displacements measured for the same cantilevers as those shown in FIG. 10, but after sputtering 100 nm of gold on the surface of silicon nitride beams of FIG. 10. This new laminate material exhibits greater bending moment, as evidenced by the increased deflection of the simple or flat nitride beam. The tip deflection has doubled, and the radius of curvature has been reduced by half with the introduction of the metal layer on top of the beam. By contrast, the beams with vertical stiffening elements (i.e., the T-beam, the C-beam, and the triangular lattice beam) do not exhibit measurable increases in deflection or curvature with the introduction of the metal layer. The increased bending stiffness of these elements has rendered them much less sensitive to variation in film stress.

Finite Element Analysis (FEA) and Simulations

FIG. 12 illustrates an exemplary schematic of a silicon nitride cantilever beam used for finite element analysis of various beam configurations according to one embodiment of the present invention. FIG. 13 is a finite element model corresponding to the cantilever schematic shown in FIG. 12. In FIG. 12, the cantilever is released from the substrate 70 and consists of flanges 72, a silicon nitride layer 74, and a metal layer 76. Although the experimental beams were anchored to the substrate, the substrate is slightly undercut during the final etch step as is seen by the presence of the undercut 78 in the schematic of FIG. 12. Due to the undercutting at the anchor point the flanges 72 are not anchored to the substrate. The presence of the undercut 78 was considered in the FEA model in FIG. 13 by fixing only the nodes at the base associated with the metal layer 76 and the two silicon nitride layers constituting the layer 74. FIG. 13 illustrates the boundary conditions used for the FEA model of the beam shown in FIG. 12.

Using the models in FIGS. 12 and 13, flat beams, T-beams, C-beams and triangle-lattice beams were simulated using the finite element package ANSYS 5.6 (Houston, Pa.). Each of the beam models consisted of a 1.5 μl thick silicon nitride layer (i.e., layer 74 in FIG. 12) and 100 nm thick layer of metal (i.e., layer 76 in FIG. 12). With respect to the flanges 72 (FIG. 12), the flange depth for the T-beam, C-beam and the triangle-lattice beam was set to 10 μm and the flange width was set to 1.5 μm.

FIG. 14 illustrates four finite element models for different cantilever beam configurations generated using the schematic illustrated in FIG. 12. The drawing 80 in FIG. 14 represents a finite element model of the flat beam, the drawing 82 is the finite element model of the T-beam, the drawing 84 is the finite element model of the C-beam, and the drawing 86 is the finite element model of the triangle-lattice beam. Each model measures 50 μm wide by 300 μm long. The flat beam, T-beam and C-beam take advantage of a symmetry plane along the center of the respective beam. The elastic modulus and Poisson's ratio for the low-stress silicon-nitride and the metal layers have been obtained from Xin Zhang, Tong-Yi Zhang, Yitshak Zohar, “Measurements of residual stresses in thin films using micro-rotating structures,” Thin Film Solids, 335, 97-105, 1998. A value of 220 GPa was used for the elastic modulus of the low-stress nitride and a value of 180 GPA was used for the metal. Poisson's ratio was set to 0.24 for the silicon-nitride and a value of 0.33 was used for the metal. However, residual stresses in both layers can vary considerably from one wafer to another. Consequently, Guckel rings and pointer devices are included on all the wafers as discussed in (1) H. Guckel, D. Burns, C. Rutigliano, E. Love, B. Choi, “Diagnostic microstructures for the measurement of intrinsic strain in thin films,” J. Micromech. Microeng., 2, 86-95, 1992, (2) M. Bountry, A. Bosseboeuf, J. P. Grandchamp, G. Coffignal, “Finite-element method analysis of freestanding microrings for thin-film tensile strain measurements,” J. Micromech. Microeng., 7, 280-284, 1997, and (3) Xin Zhang, Tong-Yi Zhang, Yitshak Zohar, “Measurements of residual stresses in thin films using micro-rotating structures,” Thin Film Solids, 335, 97-105, 1998, the disclosures of all these three articles are incorporated herein by reference in their entireties.

The Guckel rings and pointer devices offer a direct way to get an approximate residual stress value in the silicon nitride layer. However, these devices may not predict the stress level in the metal. In that situation, once the residual stress level in the silicon-nitride has been determined, the measured tip deflection of cantilever beams with metal can be compared to a finite element model with an assumed value for residual stress in the metal layer. The residual stress value in the model can then be adjusted so that the tip deflection of the model matches that of the experimental device. This one-point calibration scheme was used to set the stress value for the gold layer in the simulations depicted in FIG. 14.

Once the material properties for the beams were determined, the static deflection of the beams due to internal residual stresses was simulated. The stress gradient in each material was not included in the model. Instead, each material layer was given a constant residual stress value in the form of an equivalent temperature as discussed in (1) M. Bountry, A. Bosseboeuf, J. P. Grandchamp, G. Coffignal, “Finite-element method analysis of freestanding microrings for thin-film tensile strain measurements,” J. Micromech. Microeng., 7, 280-284, 1997, and (2) Staffan Greek, Nicolae Chitica, “Deflection of surface-micromachined devices due to internal homogeneous or gradient stresses,” Sensors and Actuators, 78, 1-7, 1999, the disclosure of which is incorporated herein by reference in its entirety. The stress value was entered in terms of a temperature and the temperature coefficients were modified as follows:

$$\begin{matrix}{α}_{x} = {α}_{y} = \frac{- ( 1 - v )}{E} & ( 4 ) \\ {α}_{z} = \frac{2 v}{E} & ( 5 )\end{matrix}$$

In the above equations v is Poisson's ratio and E is the elastic modulus of the material.

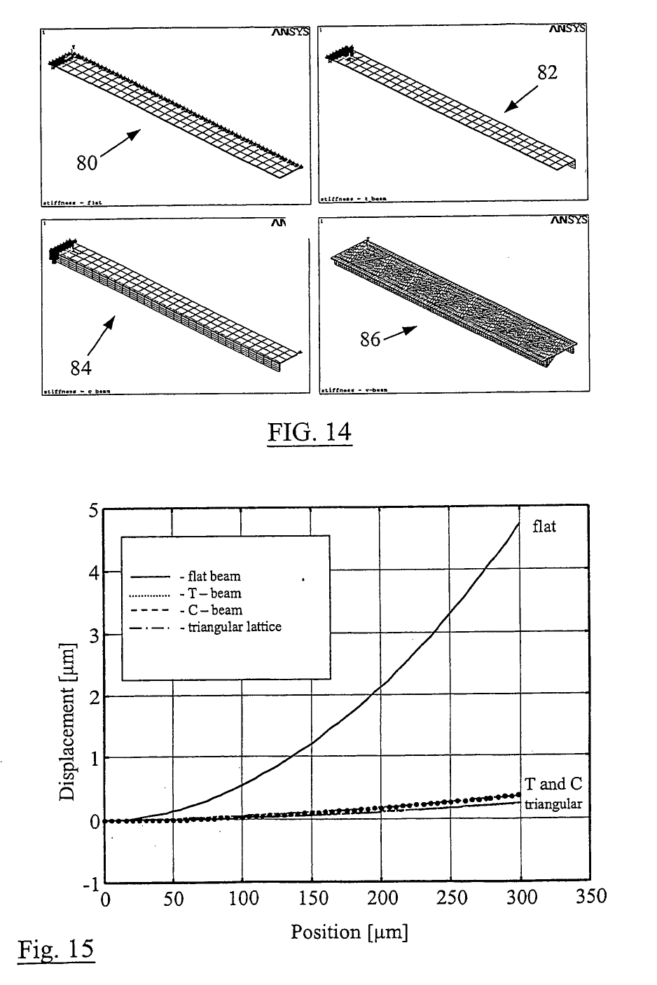

The Guckel rings yielded a residual stress value in the silicon-nitride of 150 MPa. Tip deflection comparisons for the flat beam gave a residual stress value in the metal layer of 180 MPa. These values were then applied to each of the four models and a linear analysis was conducted. FIG. 15 depicts simulated cantilever displacements for four different beam cross-sections as predicted by the finite element analysis. The simulations shown in FIG. 15 include simulations for silicon nitride beams with 100 nm gold coating. It is noted that nonlinear geometry analyses were not necessary due to the small tip displacements relative to the length of the beam. However, it is not uncommon for the stress differential between the silicon-nitride and the metal layer to be large enough to bend cantilevers and other devices into deflected shapes that require nonlinear geometry solutions. The following Table shows measured and simulated tip deflection values for the flat beam, T-beam, C-beam and the triangle-lattice beam. As can be seen from the Table given below, although the simulated tip deflections are not in exact agreement with the measured tip deflections, the general trend is towards agreement. Furthermore, it is seen that the measured and simulated beam profiles for the 50 μm by 300 μm flat beam, T-beam and C-beam from FIGS. 11 and 15 are in relatively close agreement.

Table of Measured and Simulated Tip Deflection
for Various Cantilever Beams

| | σᵣₑₛ silicon- | σᵣₑₛ | | FEA tip |
|---|---|---|---|---|
| Beam | nitride | metal | Measured tip | deflection |
| (μm × μm) | (MPa) | (MPa) | deflection (μm) | (μm) |
| Flat 50 × 300 | 150 | 180 | 4.47 | 4.71 |
| (residual stress in | | | | |
| metal layer of finite | | | | |
| element model | | | | |
| adjusted to fit | | | | |
| measured value.) | | | | |
| Flat 100 × 300 | 150 | 180 | 3.76 | 4.82 |
| C 50 × 300 | 150 | 180 | 0.32 | 0.38 |
| C 100 × 300 | 150 | 180 | 0.55 | 0.52 |
| T 50 × 300 | 150 | 180 | 0.27 | 0.37 |
| Triangle 50 × 300 | 150 | 180 | 0.10 | 0.26 |

Additional Fabrication Issues

The fabrication process according to the present invention produces three-dimensional structures with improved stiffness to resist out-of-plane bending. As discussed hereinbefore, these structures may be made from a low-stress LPCVD silicon nitride, using a silicon substrate for the processing. As also described hereinbefore, in one embodiment, the process of the present invention includes etching of the silicon substrate to form deep trenches, followed by deposition of a silicon dioxide layer and then deposition of the silicon nitride material that fills the trenches and coats the surface of the substrate. It is noted that the silicon dioxide layer may be omitted for some structures. Lithographic means may be used to pattern the deposited silicon nitride material to create useful thin-film micromachined structures. These structures may be made free-standing by chemical etches that attack the silicon dioxide and/or the underlying silicon, without damaging or removing the silicon nitride material. It is noted that a substrate material other than silicon (e.g., gallium arsenide, another semiconductor or dielectric material, etc.) may be used, and a structural material other than silicon nitride (e.g., polysilicon or silicon carbide or a metal film (preferably molded) or silicon dioxide) may be used. It is further noted that, instead of or in addition to silicon nitride, the mechanical members in the micromachined device may be formed of a ceramic material or a dielectric material or another suitable material that cannot be electroplated. It is preferable to be able to etch the substrate deeply to create trenches, followed by a conformal coating process that ensures that the structural material gets deposited down in the deep surface feature (i.e., the trenches). Furthermore, appropriate etchants (either liquid, gas or plasma) that ultimately dissolve the substrate material without attacking the structural material (here, silicon nitride) should preferably be selected. Those etchants may attack the substrate isotropically (like the common acid etch HNA (hydrofluoric acid, nitric acid and acetic acid) or anisotropically like the alkaline etch TMAH. In other words, the substrate itself may be considered as a sacrificial material in the fabrication process described hereinbefore.

It may be preferable to use a deposited film material for the structural layer, followed by an etch of the substrate material in order to allow for motion of the resulting device, where the film material is either different from the substrate and not attacked by the etchant used to remove the substrate material, or else it is protected in some way such as encapsulation or by a galvanic process during the etch. An example of a galvanic etch is the common use of a p-n junction as an etch stop during KOH (potassium hydroxide) etching.

In one embodiment, narrow trenches are used so that after deposition of the silicon nitride, the trenches were completely filled and closed off at the top surface. This may allow deposition of a second thin film of metal (chrome/gold in this embodiment) to make capacitive plates for actuation of the micromachined structures, with assurance that the metal film would be continuous and electrically conductive across the stiffening features. Other suitable metal films include nickel, aluminum, or tungsten films. Closing-off the trenches after silicon nitride deposition may provide rigid micromachined structures that may resist tensile forces in the plane of the substrate but normal to the trench edges. Corrugated micromachined structures made by coating deep but wide trenches may be very compliant to such tensile stresses, pulling apart like an accordion.

In one embodiment, a polishing step is performed following the nitride deposition that closes off the trenches. Without this polishing step, surface features may exist where the vertical members or fins of micromachined structure have been formed. Therefore, it may be necessary to eliminate these features, which, preferably, may be done with a chemo-mechanical polish, resulting in a flat surface. In this way, micromachined structures such as optical mirrors may incorporate stiffening features across the entire surface, without degrading the optical properties of the surface.

As discussed hereinbefore, the stiffening members may be formed into lattices. These lattices may adopt properties that may be modeled as a bulk material, significantly simplifying the design process. On the other hand, very detailed and large finite element models to accurately represent the latticed structural detail may take a long time to simulate, hindering the design process. By extracting equivalent bulk material properties for the lattices, one can replace the latticed material with an equivalent solid material with appropriate properties, resulting in much simpler models that are useful for the design and analysis of structures that incorporate the stiffening lattices. Lattices may be designed that produce interesting or desirable bulk properties. Isotropic materials may result from symmetric lattices, such as hexagonal honeycomb structures. Anisotropic materials may result from asymmetric lattices. Further types of materials include, for example, materials with different Young's modulus along different axes, and different torsional rigidity for left-handed versus right-handed torsion. Out-of-plane bending may also be controlled by lattice engineering, allowing the construction of structures that, once released, may bend in a controlled manner. Applying a highly tensile film such as chromium film on the surface of the structures may generate a bending moment. Appropriate lattices may be engineered to achieve various curved surfaces, including cylinders, spheres and other higher order shapes. Thus, macroscopic mechanical parameters may be engineered by changing the microscopic patterns of the mold (e.g., building torsion springs that are stiffer when resisting a right-handed twist than when resisting a left-handed twist).

It is observed that because low-stress silicon nitride is not a good dielectric, some electric charge migration may occur in the silicon nitride film when an electric filed is present. With the actuating electrodes on top of the nitride film and the silicon substrate acting as the counter electrode, there is always an electric field present when silicon nitride-based micromachined devices are being operated through electrostatic actuation. In one embodiment, the devices may be actuated with AC (alternating current) voltages rather than DC (direct current) voltages in order to prevent charge migration from causing mechanical drift of the micromachined structure. The frequency of the AC drive voltage may be kept much higher than important mechanical resonance frequency of the device being actuated with the AC voltage. This results in the device just responding to the average actuation force, without causing any mechanical device drift.

FIG. 16 is a bottom-side view of a portion of a released lattice structure illustrating inclusion of silicon in the stiffening lattice for a micromachined structure. The term “top”, as used herein, refers to the top surface of a micromachined structure (e.g., the layer 76 in FIG. 12), whereas the term “bottom” refers to a view from a direction that is opposite from the top surface of the structure (e.g., the bottom of the substrate 70 in FIG. 12). The discussion of stiffened micromachined structures given hereinbefore focused on the structures made of only the deposited silicon nitride film. In those structures, care is taken to ensure that the silicon substrate from underneath the structures is preferably completely etched away. It is, however, noted that it may not be necessary to completely remove this silicon, and stiffer structures may result if the process is designed to leave some portion of the silicon as part of the structure as illustrated, for example, in FIG. 16. For the example of the cantilevers discussed hereinbefore, using the anisotropic silicon etchant TMAH without any etch vias in the lattice cells may result in the silicon being attacked from underneath the lattice as the etch progresses. Design of the lattice cells to coincide with the planes of the silicon 87 may result in a perimeter of silicon in each cell after the etch has completed, with the perimeter characterized by the exposed, slowly etching planes of the silicon 87 surrounding corresponding trenches (not shown in FIG. 16). In FIG. 16, silicon substrate planes 87 and the exposed silicon nitride layer 88 are illustrated from a bottom-side view of a portion of a released latticed structure. In one embodiment, smaller cells in the lattice may result in the silicon etch not reaching the silicon nitride film 88 from the bottom side, so that no silicon nitride gets exposed except for the lattice grid. This technique may be useful for improving the stiffness of the released structure significantly, and for adding to its mass for applications such as inertial sensing that require a massive movable element. Silicon dioxide may be a candidate material for the lattice grid in such an embodiment, since the structural properties of the resulting composite material may be determined more by the silicon than by the grid material.

Biaxial Mirrors with Stiffening Ribs

Because the fabrication methods of surface micromachined structures create stresses in the structural members upon release from the substrate and because such structures can be very compliant normal to the substrate, as discussed hereinbefore, the stresses in the members cause them to deform or bend out-of-plane. By designing an underlying structural lattice as discussed hereinbefore, the thin film micromachined structure can be made more rigid to unwanted movements, both static and dynamic. For example, as discussed with reference to FIG. 1, a lattice of structural stiffening members may be first etched into the substrate material and then backfilled with the structural material. This can be a multi-step process, where the surface is planarized between layer depositions, or a single step process where the structural material fills the lattice mold while forming the surface structure. With the use of ribbed structural members, surface micromachining, and latticed support structures, the surface deposited micromachined device can be stiffened upon release. The stiffening technique according to the present invention may be useful for inertial sensors where off-axis motions are critical to instrument performance, or in optical systems where aberrations and unwanted vibrations can influence performance (e.g., to control deformations in uni-axial and bi-axial tilt mirrors), or to fabricate Gimbal structures with optimal properties, flexure width and length and outer ring radius to result in near zero axial tension on flexures and nearly spherical curvature of central plate due to film stress gradients. As an example of micromachined devices fabricated using the process described hereinbefore with reference to FIG. 1, the following discusses gold-coated silicon nitride micro mirrors designed for two orthogonal rotations.

As discussed hereinbefore, FIG. 6 illustrates an isometric view 42 of an exemplary biaxial micro mirror released from the substrate after being formed according to the process depicted in FIG. 1. Whereas, FIG. 5 illustrates top and cross-sectional views of a bi-axial micro mirror. Micromachined silicon nitride mirrors are used to redirect light, in optical telecommunication systems, in endoscopic imaging devices, etc. In a bi-axial micro mirror, two orthogonal flexures are used to support a reflective coated silicon nitride mirror. Applying voltages to surface electrodes can angularly deflect the mirror. As discussed before, a combination of two techniques—bulk and surface micromachining—can produce structures that can be made stiffer and have larger angular deflections, yet are easily produced. In case of the micro mirror in FIG. 6, the mechanical members and mirror surface are made using standard surface micromachining techniques with structures to add rigidity to the members then released using a wet bulk etch of silicon substrate. Mirror diameters ranging from 100 μm to 500 μm were fabricated with electrostatic actuation used to achieve over four degrees of tilt for each axis.

As discussed before with reference to the process in FIG. 1, the micro mirror devices in FIGS. 5 and 6 were released by etching the sacrificial PSG and thermal oxide with a hydrofluoric acid (HF) solution. The clearance for mechanical motion was then produced by anisotropic etching the silicon substrate in a TMAH solution. Various concentrations and etch temperatures were used. In one embodiment, a 5% solution of TMAH at 80° C. produced an etch rate of 25 μm/hr under the silicon nitride with the stiffening ribs. The silicon etch in TMAH was timed to produced the desired recess under the biaxial mirrors. In another embodiment, thirty-two different biaxial mirror designs and numerous test structures were produced on a die with 34 dies on a four-inch wafer. The biaxial mirrors had a range of flexure geometries and dimensions, stiffening members, actuator sizes and reflective surface dimensions. FIG. 17 illustrates an exemplary released bi-axial micro mirror 90 with standard torsional hinges. On the other hand, FIG. 18 illustrates an exemplary released bi-axial micro mirror 92 with meander hinges. Other geometry for the flexures includes recessed hinges (not shown).

The micro mirror 90 in FIG. 17 has a reflective surface with a 150 μm diameter with inner actuator 50 microns wide and outer electrode 100 microns wide. The flexures are all 50 μm long with inner flexure width being 6 μm and outer flexure width being 8 microns. The micro mirror 90 has two individual stiffening rings with webbing on the outer member and one webbed stiffening ring on the inner member.

FIG. 19 shows some details of an inner flexure for the released bi-axial mirror 90 in FIG. 17. The step down between the two layers of nitride can be seen as arcs (for example, the arc 94 in FIG. 19) at the end of the flexures. Also partially visible are the undulations over the backfilled trenches near the top of the image in FIG. 19. In the embodiment in FIGS. 17 and 19, the cusps over the backfilled trenches create a surface unsuitable for a reflective mirror, therefore no trenches were incorporated in the mirror area. The substrate under the mirror is flat to within a few microns. FIG. 20 shows the backside of another biaxial mirror fabricated using the process described with reference to FIG. 1. The backfilled trenches 96 that increase the structural strength of the device can be seen in FIG. 20. The height of the lattice-work may be determined by the etch depth into the silicon substrate, which may be typically 10-15 microns. Various geometries of lattice-work may be produced ranging from simple concentric rings to interlaced webbings that completely fill the dimensions of the micromachined structure.

In the electrostatically actuated tilting mirror made of silicon nitride according to present invention, standard surface micromachining techniques of lithography, wet and dry etching and thin films deposition are used. It is noted that the mirror with stiffening members according to the present invention uses a substrate material (in this case silicon) that is different from the structural material (in this case silicon nitride), which allows a post-processing etch step to selectively etch the silicon substrate to an arbitrary depth underneath the released silicon nitride mirror, without damaging the mirror. In this way, deep recesses under the device may be fabricated, allowing for large angular deflection of the mirror. Silicon nitride is used because of its good optical properties, low tensile stress, its ability to support multiple metal actuators on its surface, its dielectric properties, and excellent mechanical properties that make it not susceptible to fatigue. It is noted that although silicon nitride and silicon are used as the structural material and substrate material, respectively, other materials may be used too. For example, the mirror may be formed from a variety of metal films such as nickel, aluminum or tungsten, and other semiconducting materials such as polysilicon or dielectrics such as silicon carbide. In the case of polysilicon, a non-silicon substrate material should preferably be used.

In one embodiment, the use of silicon nitride, which is a dielectric, allowed the use of top-side electrodes for electrostatic actuation. In that embodiment, chromium was deposited (for adhesion promotion) followed by gold deposition, and then electrodes were lithographically patterned for capacitive actuation. The counter electrode was the silicon substrate wafer. Other configurations may be devised. For instance, the counter electrode may be on some other surface placed adjacent to and substantially parallel to the silicon substrate. An example may be indium-tin-oxide coated glass. Also, the mirror may be coated with a continuous metal film, with patterned actuation electrodes provided on an adjacent surface for the control of angular motion of the mirror. The substrate may be etched clear through, allowing optical access to the mirror from underneath. The use of a metal film material for the mirror structure may necessitate the use of an adjacent surface with patterned electrodes on it.

Other actuation means may be devised, including electromagnetic, with either fixed magnets or electromagnets incorporated onto the mirror structure. Fixed magnets may be a film variety, deposited during the fabrication of the mirror, or they may be other types of magnets glued with an adhesive after the fabrication process was complete. An electromagnet may be formed with a deposited and/or plated coil incorporated onto the central plate of the mirror. Passing a current through this coil would generate a magnetic moment that may be acted upon by external magnetic fields. Combinations of electrostatic and electromagnetic actuation are also possible. Actuation provided by a mechanical coupling mechanism, rather than by direct actuation on the mirror or gimbal ring are also possible. For instance, comb drive actuators may be used, with a mechanical coupling provided to the mirror or ring.

Internal film stress gradients and the stress differential in multilayer films may cause mirror curvature. Control of the surface curvature of an optical mirror may be achieved in two ways. The first is by taking advantage of the gimbal structure of a bi-axial tilt mirror. Changing the shape of the outer ring changes the way in which it curves, which in turn changes the tension applied to the torsion hinge connecting to the inner plate. Large tension on the hinges may lead to inner plate shapes that are more cylindrical, adding astigmatism to the optical beam reflecting from the plate. Compression of the hinges may lead to hinge buckling and unpredictable mechanical behavior. A small tensile force may allow the inner plate to curve in a more spherical shape, minimizing aberrations introduced onto the optical beam. This tensile stress may be controlled by engineering the outer gimbal ring shape.

The second approach to control mirror curvature is the incorporation of stiffening structures into the mirror. This approach is described hereinbefore where the substrate is first etched with a narrow trench pattern, prior to deposition of the silicon nitride structural material. These trenches are filled up and closed off during the nitride deposition, resulting in 3-dimensional film structures with significantly improved resistance to out-of-plane bending. Use of various lattice designs allows one to tailor the mechanical bending properties of these stiffened structures. In this way, the bending of both the central disk and the outer ring of the gimbal may be controlled. Furthermore, the tension felt by the inner torsion hinge may be controlled (achieving either tension or compression in that element), and thereby the residual curvature of the inner plate may also be controlled. With the use of stiffening structures, the flatness of the mirror may be maintained to meet optical tolerances.

In one embodiment, the mirrors fabricated according to the method of the present invention (as illustrated, for example, in FIG. 1) have stiffening features incorporated around the perimeter of the central mirror plate, and onto the gimbal ring. No stiffening ribs are used in the area where the optical beam will strike the mirror, since such ribs may result in surface features that may cause scattering of the optical energy in the beam. A polishing step may be introduced into the process after the nitride deposition so that stiffening structures could be used across the entire mirror plate, without compromising optical quality of the mirror surface. Micromirrors with honeycombed lattices across the entire mirror may also be fabricated using the method of the present invention, with an accompanying improvement in the flatness of the resulting mirror structures.

It is noted that although only bi-axial mirrors are described herein in detail, the fabrication process according to the present invention applies equally to uni-axial mirrors, which suffer much the same complications of the bi-axial mirrors. Such uniaxial mirrors don't have an outer gimbal ring around the mirror plate. Other useful mirror structures may also be fabricated using the method of the present invention. For example, translational mirrors designed for motion perpendicular to the plane of the substrate surface (often called piston mode motion) may be fabricated using the process of the present invention. Scanning interferometers may benefit from such mirrors. Optically flat mirrors, or mirrors with controlled curvature of the optical surface that are designed to operate with a large initial tilt angle, up to or exceeding 90 degrees may also be fabricated using the process of the present invention. Such “pop-up” mirrors may be useful for micro-optical systems that include an optical beam propagating parallel to the substrate surface.

Surface modifications to the mirrors described hereinabove may result in diffraction gratings with tilt control, or multilayer thin films with tilt control. Such modifications may include additional lithographic, deposition or etching steps. Applications of such structures may include wavelength specific mirrors or polarization control optical elements, beamsplitters, etc. An important feature of such structures according to the present invention is the use of a deposited film material (e.g., silicon nitride) for the structural layer, preferably with the inclusion of stiffening features, followed by an etch of the substrate mold in order to allow for motion of the device, where the film material is either different from the substrate and not attacked by the etchant used to remove the substrate material, or else it is protected in some way such as encapsulation or by a galvanic process during the etch. An example of a galvanic etch is the common use of a p-n junction as an etch stop during KOH (potassium hydroxide) etching. It is observed that significantly stiffer mirrors may be fabricated from the intentional inclusion of some silicon into the silicon nitride stiffening lattice in the manner discussed hereinbefore with reference to FIG. 16.

Experimental Results (Bi-Axial Mirrors)

In one embodiment, several of the dies on the substrate wafer were produced without first etching the silicon surface. These dies were without the stiffening ribs. This allowed for a direct comparison of identical devices from the same wafer that have the stiffening members and those without the stiffening structures. Upon comparison of the images of these two structures, the deformation of the bi-axial mirror without stiffening ribs was evident by numerous fringes throughout the device as compared to a very few fringes for the device with stiffening ribs. However, the mirror with stiffening ribs still had some curvature (represented in the mirror's electron microscope image by concentric fringes on the mirror as compared to the straight fringes seen on the flat substrate of the mirror), but substantially less curvature than that present in the mirror without stiffening ribs. The reflective portion of the device (with stiffening ribs) was 150 microns in diameter and had less than one fringe across it. The source of the curvature in the device with stiffening ribs was the stress induced on the loss stress nitride by the chrome-gold metal layers. Typically, the nitride has stress levels of 50-100 MPa, and the 50A of chrome and 1000A of gold create additional stress in the layered film.

In one embodiment, a bi-axial mirror fabricated with stiffening ribs using the methodology of the present invention was electrostatically actuated and its interferometric images were taken to profile the effect of actuation on the mirror. In the static case with no applied voltage, the interferometric image of the mirror exhibited some fringes that were due to the combination of the surface deformation and substrate tilt, which was visible at the top of the image. It was apparent from the static case image that there was some curvature on the outer member of the mirror as demonstrated by the nonlinear fringe pattern, but the center of the mirror was relatively flat since its fringe pattern was nearly linear. In the case of an applied potential between the substrate and the electrode on the left side of the outer member of the micro mirror, an electrostatic torque was created by the applied voltage that tilted the entire mechanical structure as could be seen from the image. Similarly, applying a voltage to the right electrode tipped the mirror and the supporting outer member to the right. The adjustment of the relative potentials between the right and left electrodes and the substrate produced over plus and minus four degrees of rotational motion. When a potential was applied to the upper electrode, the corresponding image showed the inner support member for the mirror tilted up as expected, but there was some movement about the orthogonal axis. This could be noted in the image by the increased number of fringes across the outer member when compared to the static case. Initial finite element analysis demonstrates that some off primary axis motion may be due to the asymmetric design. Different mirror designs had different coupling magnitudes. Some demonstrated almost no coupling but others had significant cross axis motion.

The foregoing describes a method to fabricate stiffened surface micromachined structures including, for example, micro mirrors. A silicon substrate is first etched to produce a mold containing a plurality of trenches or grooves in a lattice configuration. Sacrificial oxide is then grown and/or deposited on the silicon substrate and then a stiffening member (silicon nitride) is deposited over the surface of the substrate, thereby backfilling the grooves with silicon nitride. The silicon nitride is patterned to form mechanical members and metals are then deposited and patterned to form the leads and capacitors for electrostatic actuation of mechanical members. The underlying silicon and sacrificial oxides are removed with a wet etch. The mold is etched from underneath the fabricated micromachined devices, leaving free-standing silicon nitride devices. The micromachined devices built with vertical features or fins or ribs created by molding the substrate and backfilling the mold with silicon nitride exhibit increased out-of-plane bending stiffness. The increased bending stiffness resulting from stiffening fins or ribs substantially reduce stress-related deformations experienced by surface-micromachined devices with large length-to-thickness ratios. Thus, by using surface micromachining techniques to pattern stiffened micromachined devices out of silicon nitride and then releasing them by a sacrificial oxide etch and bulk etching of the silicon substrate, the out-of-plane deformation of the released micromachined structures can be significantly reduced.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the features of the invention hereinbefore set forth and as follows in the scope of the appended claims.

1. A method of fabricating a thin-film micromachined device comprising:
etching a substrate to produce a mold therein;
depositing a structural stiffening member on said substrate so as to backfill said mold with said structural stiffening member;
patterning said stiffening member deposited on said substrate to form said thin-film micromachined device on said substrate; and
etching said mold to release said micromachined device without removing said stiffening member that is backfilling said mold.

2. The method of claim 1, wherein said mold includes a plurality of trenches etched into said substrate in a lattice configuration.

3. The method of claim 2, wherein said lattice configuration includes at least one of the following:
a ringed lattice configuration;
a webbed ring lattice configuration;
a honeycombed lattice configuration;
a triangular lattice configuration;
a diamond lattice configuration; and
a lattice configuration designed to exhibit specified bulk materials properties that derive from an underlying lattice structure.

4. The method of claim 1, wherein etching said mold includes etching said substrate to a predetermined depth underneath said mold.

5. The method of claim 1, further comprising encapsulating said stiffening member prior to etching said mold.

6. The method of claim 1, further comprising leaving a portion of said mold incorporated into said released micromachined device during etching of said mold.

7. The method of claim 1, further comprising:
depositing a layer of conducting film on said structural stiffening member; and
patterning said layer of conducting film deposited on said stiffening member.

8. The method of claim 7, wherein said layer of conducting film includes a metal selected from the group consisting of chrome, gold, nickel, aluminum, and tungsten.

9. The method of claim 1, further comprising growing a sacrificial oxide layer on said substrate including said mold prior to depositing said structural stiffening member.

10. The method of claim 1, wherein said structural stiffening member includes at least one layer of silicon nitride.

11. The method of claim 1, wherein said substrate is a silicon substrate.

12. The method of claim 1, wherein said structural stiffening member is selected from the group consisting of silicon nitride, polysilicon, silicon dioxide, molded metal, and silicon carbide.

13. The method of claim 1, further comprising polishing said structural stiffening member deposited on said substrate prior to patterning said stiffening member.

14. The method of claim 1, wherein etching said mold includes generating a substantially uniform air gap of variable size beneath said micromachined device to be released, wherein the size of said air gap is dependent on a duration of etching of said mold.

15. A micromachined device formed by the method of claim 1.

16. A micromachined device comprising:
a structural stiffening member; and
a thin-film micromachined structure formed from said stiffening member by patterning said stiffening member,
wherein said stiffening member is initially deposited on a substrate backfilling a mold etched into said substrate, and wherein said mold is selectively etched after formation of said micromachined structure so as to release said micromachined structure without removing said stiffening member that is backfilling said mold.

17. The device of claim 16, wherein said substrate is a silicon substrate.

18. The device of claim 16, wherein said structural stiffening member is selected from the group consisting of silicon nitride, polysilicon, silicon carbide, metal, and silicon dioxide.

19. The device of claim 16, further comprising a layer of metal deposited and patterned on said structural stiffening member.

20. The device of claim 19, wherein said layer of metal includes a metal selected from the group consisting of chrome, gold, nickel, aluminum, and tungsten.

21. The device of claim 16, further comprising a portion of said mold incorporated into said released micromachined structure.

22. The device of claim 16, wherein said mold includes a plurality of trenches etched into said substrate in at least one of the following lattice configurations:
a ringed lattice configuration;
a webbed ring lattice configuration;
a honeycombed lattice configuration;
a triangular lattice configuration;
a diamond lattice configuration; and
a lattice configuration designed to exhibit specified bulk materials properties that derive from an underlying lattice structure.

23. The device of claim 22, wherein orientation of each of said plurality of trenches is substantially vertical.

24. The device of claim 16, further comprising a substantially flat air gap beneath said micromachined structure released upon selective etching of said mold.

25. A micromachined mirror comprising:
a structural stiffening member containing at least one layer of silicon nitride;
one or more mechanical members formed from said stiffening member by patterning said stiffening member; and
one or more layers of metal deposited and patterned on said stiffening member so as to form a reflective portion of said micromachined mirror and one or more electrostatic actuators for said mechanical members,
wherein said stiffening member is initially deposited on a silicon substrate backfilling a mold etched into said substrate, and wherein said mold is selectively etched after patterning said one or more metal layers so as to release said micromachined mirror without removing said stiffening member that is backfilling said mold.

26. The mirror of claim 25, wherein said one or more layers of metal include a metal selected from the group consisting of chrome, gold, nickel, aluminum, and tungsten.

27. The mirror of claim 25, wherein said mold includes a plurality of trenches etched into said substrate in at least one of the following lattice configurations:
a ringed lattice configuration;
a webbed ring lattice configuration;
a honeycombed lattice configuration;
a triangular lattice configuration; and
a diamond lattice configuration.

28. The mirror of claim 27, wherein each of said plurality of trenches is etched substantially vertically into said substrate.

29. The mirror of claim 27, wherein a diameter of said reflective portion is in the range of 100-500 microns and wherein a vertical depth of each of said plurality of trenches is in the range of 10-100 microns.

30. The mirror of claim 25, where said mold includes a plurality of trenches etched into said substrate in a lattice configuration that is designed to achieve specified tension or compression in the torsional flexures of said one or more mechanical members.

31. The mirror of claim 25, further comprising a substantially uniform air gap beneath said micromachined mirror released upon selective etching of said mold.
